(19) United States
(12) Patent Application Publication
(10) Pub. No.: US 2023/0337339 A1
(43) Pub. Date: Oct. 19, 2023

(54) SYSTEM AND METHOD OF CONTROLLING A MICROWAVE HEATING CYCLE

(71) Applicant: THE COCA-COLA COMPANY, Atlanta, GA (US)

(72) Inventors: Michael J. GOCLON, Salt Lake City, UT (US); Steven Romel GIVENS, Atlanta, GA (US)

(21) Appl. No.: 18/022,206

(22) PCT Filed: Aug. 25, 2021
(86) PCT No.: PCT/US2021/047490

§ 371 Date: Feb. 20, 2023

Related U.S. Application Data
(60) Provisional application No. 63/071,475, filed on Aug. 28, 2020.

(51) Int. Cl. H05B 6/64

(52) U.S. Cl. CPC H05B 6/645

(57) ABSTRACT

A microwave appliance provides safe heating of a food product within a food container to within a tolerance of a temperature selection despite the temperature of the food container being different than the temperature of the food product. The temperature of the food product may be higher than the temperature of the food container, particularly for higher temperature settings for the food product. A control method is provided herein to calculate a target temperature of the food container at which a heating cycle is to be stopped. The control method stops the heating cycle when the measured temperature of the food container reaches the target temperature. A temperature of the microwave cavity also affects the measured temperature of the food container. Accordingly, the temperature of the microwave cavity may be used to determine an adjustment to the target temperature of the food container.

### CROSS REFERENCE TO RELATED APPLICATIONS

This application claims the benefit of U.S. Provisional Application Ser. No. 63/071,475 filed Aug. 28, 2020, the disclosure of which is expressly incorporated herein by reference.

### BACKGROUND

Typical microwaves do not have safety features that can facilitate use of the microwave with an enclosed package while preventing rupture of the enclosed package. Such enclosed packages can unexpectedly rupture as a result of prolonged operation of the microwave. Accordingly, opened, vented, or otherwise unsealed food containers or packaging are used in typical microwaves. Therefore, typical microwaves may be exposed to splatter of food products from the opened food containers during use.

### SUMMARY

A first aspect of the disclosure provides a microwave appliance comprising one or more microwave sources and a microwave chamber in electromagnetic communication with the one or more microwave sources. The microwave appliance comprises a product holder configured to support a food container within the microwave chamber and a temperature sensor configured to sense a temperature of the food container supported within the product holder. The microwave appliance comprises a user interface configured to receive a temperature selection. The microwave appliance comprises a controller in communication with the temperature sensor and the user interface configured to determine a target temperature of the food container based on the temperature selection. The controller is configured to operate the one or more microwave sources to heat a food product in the food container until the temperature of the food container is equal to the target temperature of the food container.

In some implementations of the first aspect of the disclosure, the controller is configured to determine the target temperature of the food container based on a model of experimental results that relates the temperature of the food container to a temperature of the food product in the food container.

In some implementations of the first aspect of the disclosure, the food product is sealed within the food container.

In some implementations of the first aspect of the disclosure, the model is a second-order polynomial equation,

T_{c}=(X*Tₚ²)−(Y*Tₚ)+Z,

where T_{C} is the target temperature of the food container, T_{P} is the temperature selection, and each of X, Y, and Z are constants determined based on the experimental results.

In some implementations of the first aspect of the disclosure, the microwave appliance further comprises a product identification scanner in communication with the controller and configured read an identifier on the food container. The controller is configured to determine a product attribute of the food container based on the identifier.

In some implementations of the first aspect of the disclosure, the model includes an attribute multiplier that scales the target temperature of the food container based on the product attribute.

In some implementations of the first aspect of the disclosure, the product attribute is selected from the group of product attributes consisting of: a type of food product, a type of packaging, a size of packaging, and combinations thereof.

In some implementations of the first aspect of the disclosure, the microwave appliance further comprises a second temperature sensor configured to sense a temperature of the microwave chamber, wherein the model includes a cavity temperature adjustment that is added to the target temperature of the food container based on the temperature of the microwave chamber.

In some implementations of the first aspect of the disclosure, the cavity temperature adjustment is 0° C. when the temperature of the microwave chamber is 22° C., 4° C. when the temperature of the microwave chamber is 85° C., and a linear extrapolation therebetween for other temperatures of the microwave chamber.

In some implementations of the first aspect of the disclosure, the controller is configured to operate the one or more microwave sources to heat the food product in the food container temperature to within a tolerance of the temperature selection, wherein the tolerance is +/−5%.

A second aspect of the disclosure provides a method of operating a microwave appliance. The method comprises receiving a temperature selection from a user interface. The method comprises determining a target temperature of a food container based on the temperature selection. The method comprises powering one or more microwave sources to heat a food product in a food container within a microwave chamber. The method comprises sensing a temperature of the food container with a temperature sensor. The method comprises turning off power to one or more microwave sources upon the temperature of the food container reaching the target temperature.

In some implementations of the second aspect of the disclosure, determining the target temperature of the food container is based on a model of experimental results that relates the temperature of the food container to a temperature of the food product in the food container.

In some implementations of the second aspect of the disclosure, the food product is sealed within the food container.

In some implementations of the second aspect of the disclosure, the model is a second-order polynomial equation,

T_{c}=(X*Tₚ²)−(Y*Tₚ)+Z,

where T_{C} is the target temperature of the food container, T_{P} is the temperature selection, and each of X, Y, and Z are constants determined based on the experimental results.

In some implementations of the second aspect of the disclosure, the method further comprises identifying the food container based on scanning an identifier on the food container by a product identification scanner. The method further comprises determining a product attribute of the food container based on the identifier.

In some implementations of the second aspect of the disclosure, the model includes an attribute multiplier that scales the target temperature of the food container based on the product attribute.

In some implementations of the second aspect of the disclosure, the product attribute is selected from the group of product attributes consisting of: a type of food product, a type of packaging, a size of packaging, and combinations thereof.

In some implementations of the second aspect of the disclosure, the method further comprises sensing a temperature of the microwave chamber with a second temperature sensor. The model includes a cavity temperature adjustment that is added to the target temperature of the food container based on the temperature of the microwave chamber.

In some implementations of the second aspect of the disclosure, the cavity temperature adjustment is 0° C. when the temperature of the microwave chamber is 22° C., 4° C. when the temperature of the microwave chamber is 85° C., and a linear extrapolation therebetween for other temperatures of the microwave chamber.

In some implementations of the second aspect of the disclosure, the food product in the food container is heated to a temperature within a tolerance of the temperature selection, wherein the tolerance is +/−5%.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a front view of a microwave appliance for heating packaged food products to a desired temperature.

FIG. 2 is a perspective view of the microwave appliance with the door opened.

FIG. 3 is a left perspective view of the microwave appliance with the microwave access panel removed.

FIG. 4 is a right perspective view of the microwave appliance with the electronics access panel removed.

FIG. 5 is a block diagram of the micro-controller assembly of the microwave appliance.

FIG. 6 is a block diagram of the computer system of the microwave appliance.

FIG. 7 is flow diagram of a control algorithm for a heating cycle performed by the microwave appliance.

FIGS. 8A-8E are plots of experimental data and determined trend lines correlating a package temperature to a product temperature for various products.

FIG. 9 illustrates an exemplary computer system suitable for implementing the several embodiments of the disclosure.

### DETAILED DESCRIPTION

It should be understood at the outset that although illustrative implementations of one or more embodiments are illustrated below, the disclosed systems and methods may be implemented using any number of techniques, whether currently known or in existence. The disclosure should in no way be limited to the illustrative implementations, drawings, and techniques illustrated below, but may be modified within the scope of the appended claims along with their full scope of equivalents. Use of the phrase “and/or” indicates that any one or any combination of a list of options can be used. For example, “A, B, and/or C” means “A”, or “B”, or “C”, or “A and B”, or “A and C”, or “B and C”, or “A and B and C”.

A microwave appliance is disclosed herein to facilitate reliable and efficient heating of packaged food products. The microwave appliance includes a temperature sensor configured to sense a temperature of the packaged food product. In some implementations, the temperature sensor is a contactless temperature sensor configured to sense a temperature of the packaged food product from outside of a microwave chamber. Using a contactless temperature sensor prevents interaction between the temperature sensor and microwave radiation used in heating the packaged food product. For example, the temperature sensor may be an infrared temperature sensor arranged to sense infrared radiation emitted by the packaged food product. In another example, an ultrasound sensor may be used to sense a temperature of the packaged food product. Other contact-based or contactless temperature sensors may be used.

As opposed to a time-based operation as with traditional microwave appliances, operation of the disclosed microwave appliance may be based on the measured temperature of the packaged food product determined by the temperature sensor. In use, a consumer may select a desired product temperature. The desired product temperature may be an absolute temperature input received via input on a user interface (e.g., 52° C.) or a relative temperature input (e.g., ambient, hot, very hot) received via input on the user interface. The relative temperature inputs may be configurable by a technician to a particular set point (e.g., an ambient selection corresponds to 25° C., a hot selection corresponds to 55° C., etc.). The temperature-based operation of the microwave appliance may be used with a variety of sizes and types of packaged food products while ensuring that a product is not overheated in use. Additionally, a packaged food product may be re-heated or a partially filled packaged food product may be safely heated to the desired product temperature. A maximum operation time may also be used as a fail safe against failure of the temperature sensor.

However, the temperature of the food container is not an accurate measurement of a food product (e.g., beverage, soup, etc.) contained therein. The temperature of the food product may be higher than the temperature of the food container, particularly for higher temperature settings for the food product. A control method is provided herein to calculate a target temperature of the food container at which a heating cycle is to be stopped. The control method stops the heating cycle when the measured temperature of the food container reaches the target temperature of the food container. The control method results in a final food product temperature within a tolerance (e.g., within +/−5%) of a temperature selection received from a consumer on the user interface at the start of the heating cycle.

The control method uses test data of various categories and volumes of food products (e.g., beverages) to be heated in the microwave appliance to determine correlation values specific to a particular food container placed within the microwave appliance. The control method uses a lookup table, which has correlation values for different combinations of food product attributes to use to calculate the target temperature of the food container. In some implementations, the calculation is a second-order polynomial equation which correlates the measured temperature of the food container to a temperature of the food product contained therein, based on experimental data. A temperature of the microwave cavity also affects the measured temperature of the food container. Accordingly, the temperature of the microwave cavity may be used to determine an adjustment to the target temperature of the food container.

An example of a microwave appliance suitable for heating a sealed food product container is described in WO 2020/061049, titled “Packaged Food Product Microwave System and Method,” herein incorporated by reference in its entirety. An abbreviated description of the microwave appliance is provided below with reference to FIGS. 1-6. Other microwave appliances are contemplated by this disclosure to be suitable for the systems and methods described herein.

FIGS. 1-4 illustrate various views of a microwave appliance 100 suitable for heating packaged food products to a desired temperature. FIG. 1 is a front view of the microwave appliance 100 showing a door 102 and a user interface 104. The door 102 includes a window 112 for accessing the user interface 104 when the door 102 is closed.

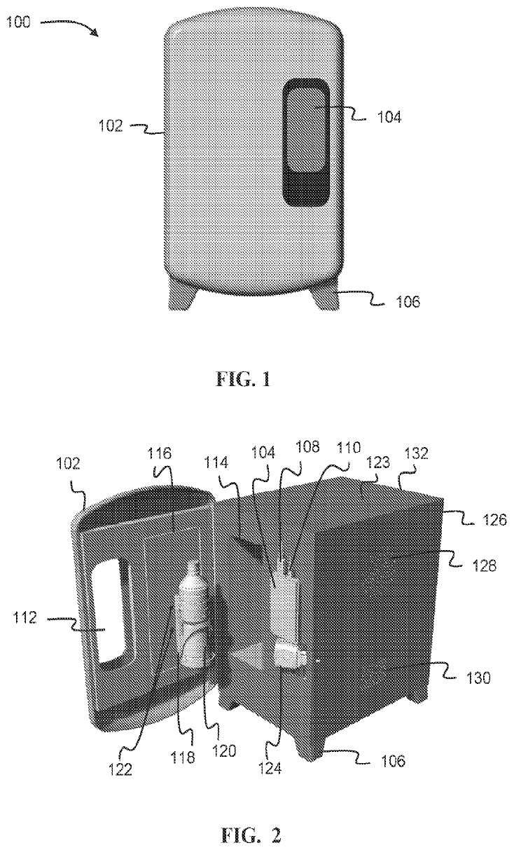

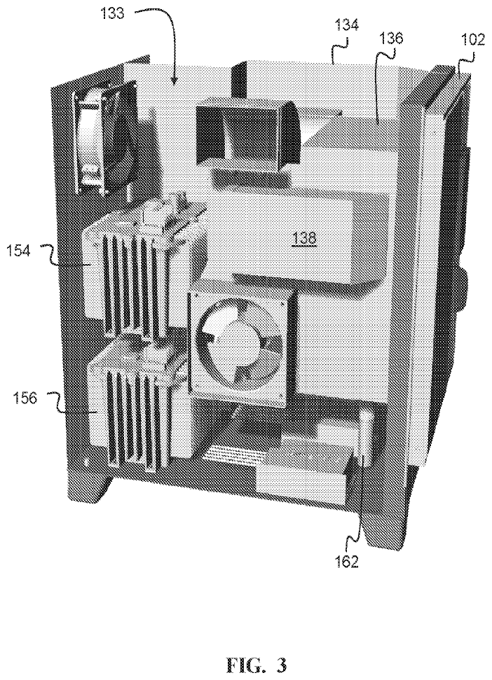

FIG. 2 is a perspective view of the microwave appliance 100 with the door 102 opened. A door switch 532 may be positioned on a front surface of a body 123 of the microwave appliance 100 or on the door 102 and provide a signal indicative of a position of the door 102 (e.g., open or closed). A holder 118 is positioned on the door and sized and shaped to receive a sealed food container 120, such as a food or beverage container. In the example shown in FIG. 2, the food container 120 is a beverage bottle. The food container 120 may be made of plastic (e.g., polyethylene terephthalate, high density polyethylene, or the like), glass, ceramic, a non-foil lined carton, or the like. The holder 118 is positioned on the door 102 to locate the food container 120 within a microwave cavity 114 when the door 102 is closed. For example, as the door 102 is rotated to a closed position, the holder 118 passes through an opening in the microwave cavity 114 to be positioned therein.

A reactive choke 116 is positioned on the door 102 around the holder 118 about a perimeter of the opening in the microwave cavity 114 when the door 102 is closed. The reactive chock 116 prevents microwave radiation from passing through the door 102 in use. One or more product presence detectors 122 are positioned on the door 102 about the product holder 118 and are configured to confirm whether the food container 120 is located within the product holder 118. The product presence detector(s) 122 may be an optical sensor or acoustic rangefinder to detect the presence of the food container 120 in the product holder 118. A plurality of product presence detectors 122 may be used to ensure detection of various sizes of food containers 120. The plurality of product presence detectors 122 may also be used to verify a size of the food container 120.

The user interface 104 is positioned on a body 123 of the microwave appliance 100. For example, the user interface 104 is positioned on the front surface of the body 123 of the microwave appliance 100. As shown in FIG. 2, the front surface of the body of the microwave appliance 100 is the same surface that includes the opening in the microwave cavity 114. The user interface 104 may be a touchscreen user interface. The user interface 104 may include a graphics port 108, such as a high-definition multimedia interface (HDMI) port, and a data port 110, such as a universal serial bus (USB) port. The graphics port 108 may supply graphics data for display on the user interface 104. The data port 110 may communicate touch or gesture inputs registered on the touchscreen. Other user interface elements may be used and communicate via the data port 110 or another data port. For example, in a vending environment, a payment module may additionally be present to facilitate receiving payment and unlocking the door 102.

A product identification scanner 124 is positioned on the body 123 of the microwave appliance 100. In the example shown in FIG. 2, the product identification scanner 124 is positioned below the user interface 104 and faces the product holder 118 when the door 102 is open. The product identification scanner 124 may be an optical scanner such as a barcode reader or camera configured to read an identifier on the food container 120. In some implementations, more than one barcode reader may be configured to read the identifier at multiple locations along the food container 120. Including multiple barcode readers facilitates identification of different food containers 120 with barcodes located at different places on the container 120 and accounts for containers 120 of varying heights.

The product holder 118 may include an opening above a base of the product holder 118 sized to facilitate a view of the identifier on the food container 120 when placed in the product holder 118. For example, the identifier may be a barcode, symbol, quick response (QR) code, or the like that encodes a universal product code (UPC) or other product identifier. The product holder 118 may be sized to allow a user to turn the food container 120 in the product holder 118 to facilitate scanning or otherwise reading the identifier on the food container 120. For example, by running the food container 120 in the product holder 118, the identifier may be located within the opening of the product holder 118 and in the view of the product identification scanner 124.

In some implementations, the product holder 118 includes a turntable on a base of the product holder 118 to facilitate easier turning of the food container 120 within the product holder 118. The turntable may be driven by a motor to automatically scan the identifier on the food container 120 within the product holder 118. The turntable motor may be activated upon the door switch providing a signal indicative of the door 102 being opened or after a predetermined delay of the door 102 being opened.

In some implementations, the identifier on the food container 120 may be scanned by the product identification scanner 124 prior to insertion into the product holder 118. In such implementations, the product presence detector(s) 122 may verify that the food container 120 has been inserted into the product holder 118 after being scanned by the product identification scanner 124.

While the product identification scanner 124 is described in an example above as an optical scanner, the product identification scanner 124 may be a wireless tag reader. For example, a wireless tag may be positioned on the food container 120, such as on a label or closure of the food container and store the identifier for the food container 120. The wireless tag may be a radio frequency identification (RFID) tag, a BLUETOOTH low energy (BLE) tag, a nearfield communication (NFC) tag, a beacon tag, or the like. The wireless tag reader of the product identification scanner 124 is configured to read the identifier for the food container 120 from the wireless tag on the food container 120.

Based on the identifier read from the food container 120 by the product identification scanner 124, the microwave appliance 100 is configured to identify a type of food product (e.g., sugar sweetened carbonated beverage, diet carbonated beverage, juice beverage, tea, coffee, smoothie, dairy beverage, yogurt product, etc.), a type of packaging (e.g., PET carbonated beverage bottle, aluminum can, aluminum bottle, hot-fill PET beverage bottle, aseptic PET beverage bottle, etc.), and/or a size of packaging (e.g., 20 fl. oz. package, 12 fl. oz. package, 8 fl. oz. package, etc.) being inserted into the microwave appliance 100. Based on the identification of the type of food product inserted, the microwave appliance 100 may identify the dielectric constant and/or electrical conductivity of the food product and adjust operation of the microwave appliance accordingly. For example, a power level of the microwave appliance 100 may be adjusted based on the dielectric constant and/or electrical conductivity of the food product. In response to reading the identifier, the microwave appliance 100 may access a local database or a network accessible database that provides one or more tables or other logical structures that associate the identifier with the type of food product, a type of packaging, a size of packaging, a dielectric constant of the food product, and/or an electrical conductivity of the food product.

The body 123 of the microwave appliance 100 comprises an electronics access panel 126 and a microwave access panel 132. The electronics access panel 126 is positioned on a right side surface of the body 123 of the microwave appliance 100. The electronics access panel 126 comprises a fan vent 128 and a duct vent 130 configured to facilitate air exchange with a surrounding environment for cooling the microwave appliance 100. The microwave access panel 132 likewise includes a fan vent (not shown) and duct vent (not shown) on a left side surface of the body 123 on the opposite side of the microwave appliance 100.

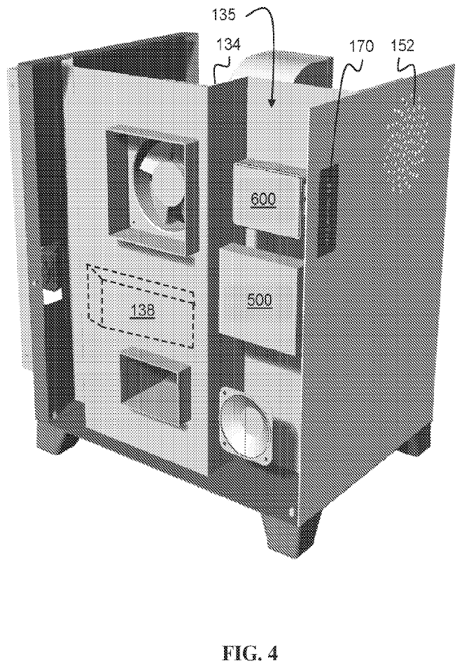

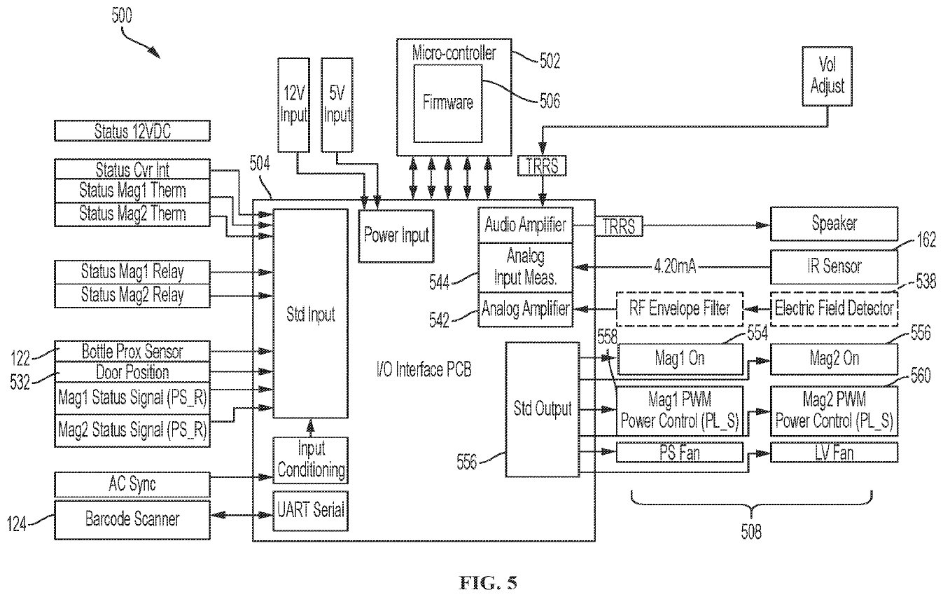

FIG. 3 is a left perspective view of the microwave appliance 100 with the microwave access panel 132 removed. The microwave access panel 132 provides access to a microwave compartment 133 with the microwave components of the microwave appliance 100. FIG. 4 is a right perspective view of the microwave appliance 100 with the electronics access panel 126 removed. The electronics access panel 126 provides access to an electronics compartment 135. The microwave compartment 133 and the electronics compartment 135 are separated by a partition wall 134.

The microwave compartment 133 includes a microwave chamber 136 provides an enclosed volume for receiving the holder 118. The microwave chamber 136 includes surfaces that reflect microwave radiation within the chamber 136. For example, the sides of the microwave chamber 136 may be made of a metal such as aluminum or steel. The microwave chamber 136 may include an electric field detector 538 for measuring an electric field within the microwave chamber 136. The electric field detector 538 may be used to estimate a volume of product within the food container 120.

The microwave chamber 136 receives microwave radiation from one or more waveguides, such as waveguide 138 and a waveguide 144. The waveguide 144 is shown in dashed lines in FIG. 4 to illustrate that the waveguide 144 is on the other side of the partition wall 134. The waveguide 138 is offset in a vertical direction from the waveguide 144 on the microwave chamber 136. A magnetron may be positioned about each of the one or more waveguides, respectively. A first magnetron (not shown) is positioned about the waveguide 138 for supplying microwave radiation to the waveguide 138. The first magnetron includes an antenna located within the waveguide 138. The waveguide 138 is configured to direct the received microwave radiation into the microwave chamber 136 along a first surface of the microwave chamber 136. Likewise, a second magnetron (not shown) is positioned about the waveguides 144 for supplying microwave radiation to the waveguide 144. The second magnetron includes an antenna located within the waveguide 144. The waveguide 144 is configured to direct the received microwave radiation into a second surface the microwave chamber 136 along a second surface of the microwave chamber 136.

While two magnetrons are disclosed, more or fewer magnetrons may be used. An additional waveguide may be provided for each such additional magnetron. Providing additional magnetrons enables the creation of more complex patterns of standing waves for ensuring strong coupling to the food product in a larger variety of food containers 120.

In some implementations, depending on the product identified by the product identification scanner 124 a power level of one or more of the magnetrons may be adjusted or turned off during use. For example, because the waveguide 138 introduces microwave radiation into the microwave chamber 136 at a location higher from the waveguide 144, if a short bottle or other food container 120 is placed in the product holder 118, then the first magnetron may be reduced or turned off during use.

While the example shown in FIG. 3 provides waveguides 138, 144 for supplying microwave radiation to the microwave chamber 136 from opposite sides of the microwave chamber 136, other configurations may be used. In some implementations, a solid state microwave source may be used instead of one or more of the magnetrons.

The microwave compartment 133 also includes a first magnetron power supply 154 and a second magnetron power supply 156 for powering the magnetrons positioned about the waveguides 138, 144. The magnetron power supplies 154, 156 may be a half-wave voltage doubler power supply or an inverter or switch mode power supply. Other power supply types may also be used.

A temperature sensor 162 is positioned about the bottom surface of the microwave chamber 136 and configured to measure a temperature of the food container 120 in the product holder 118 when the door 102 is closed. In various implementations, the temperature sensor 162 may be positioned in other locations to sense a temperature of the food container 120. The temperature sensor 162 may be a contactless temperature sensor configured to sense a temperature of the packaged food product from outside of a microwave chamber. Using a contactless temperature sensor prevents interaction between the temperature sensor and microwave radiation used in heating the food product in the food container 120. For example, the temperature sensor 162 may be an infrared temperature sensor arranged to sense infrared radiation emitted by the food product in the food container 120. In another example, an ultrasound sensor may be used to sense a temperature of the packaged food product. Other contact-based or contactless temperature sensors may be used. In some implementations, an additional temperature sensor (not shown) may be positioned to measure a temperature within the microwave cavity 114.

The food container 120 may have a variety of shapes and sizes and have product labels at different locations. The product label may insulate or otherwise impact a temperature reading for the food container 120 by the temperature sensor 162. However, the base of food containers 120 typically have less variety or variability, particularly at a central location of the base of the food container 120. For example, beverage containers typically have a flat or petaloid shaped base. Even with a petaloid shaped base, a central location of the base of the beverage container is largely uniform. Additionally, product labels are rarely located on the base of the food container 120.

The temperature sensor 162 is arranged to face towards a bottom of the product holder 118 when the door 102 is closed. The bottom of the product holder 118 may include a hole or aperture through which the temperature sensor 162 may view the base of the food container 120. Measuring the temperature from the bottom of the food container 120 allows for accurately sensing a temperature of a greater variety of package types by not needing to take into account different package sizes, shapes, and product label positions. The temperature may be measured from other locations on the food container 120, such as along a sidewall, closure, or other location on the food container.

As best seen in FIG. 4, the electronics compartment 135 includes a computer system 600 and a micro-controller assembly 500. A port access door 170 is located on the rear surface of the body 123 of the microwave appliance 100 provides access to one or more input/output (I/O) ports on the computer system 600. The partition wall 134 isolates the components in the electronics compartment 135 from heat and electromagnetic noise generated form components in the microwave compartment 133.

FIG. 5 is a block diagram of the micro-controller assembly 500 of the microwave appliance 100. The micro-controller assembly 500 includes a micro-controller 502 and an I/O interface board 504. The I/O interface board 504 is configured to receive and communicate various input signals to the micro-controller 502. The micro-controller 502 includes firmware 506 for processing the received input signals and generating output control signals 508. The I/O interface board 504 supplies the output control signals 508 to control components of the microwave compartment 133.

The I/O interface board 504 also receives analog inputs from the temperature sensor 162 and an electric field detector 538. As noted above, the electric field detector 538 may be used to estimate a volume of product within the food container 120. Additionally, the electric field detector 538 may be used to verify that electric fields within the microwave chamber 136 are in an expected range of normal operation. For example, if a metallic food container 120, such as a 12 oz. aluminum can, were inserted into the microwave appliance 100, the electric field detector 538 would sense a lower than expected or zero value load. At the same time, the product presence detector(s) 122 would sense that the food container 120 is present in the product holder 118. Similarly, if no product were inserted into the microwave appliance 100, the electric field detector 538 would sense a lower than expected or zero value load. The product presence detector(s) 122 would also sense that no product is present in the product holder 118. In either case, operation of the microwave appliance 100 may be prevented from being started or otherwise terminated upon the electric field detector 538 sensing a load value below an allowable minimum as indicated by a maximum allowable electric field threshold value.

The maximum electric field threshold value may correspond to a minimum amount of volume of a given type of food product in a given food container 120. For example, the maximum threshold value may be an expected electric field reading that corresponds to at least 5%, 10%, or 25% of a volume of a given food container 120 for the type of food product contained in the given food container 120.

Different materials have different dielectric constants and electrical conductivity thus couple to, absorb, or otherwise react to microwave radiation differently. For example, the dielectric constant of PET is about 1-3 ε′ whereas water has a dielectric constant of about 80 ε′. Likewise, the electrical conductivity of PET is about 10⁻²¹ S/m, whereas saline water solutions have an electrical conductivity of around 1-5 S/m. Therefore, food products much more readily absorb microwave radiation than the containers in which they are typically contained.

However, different food products have different electrical properties. Based upon the electrical properties (e.g., dielectric constant and/or electrical conductivity) of the food product being inserted into the microwave chamber 136, such as based on a reading from the product identification scanner 124, and a detected electric field strength measured by the electric field detector 538, a volume of the food product may be estimated. Using the estimated volume of food product inserted into the microwave chamber 136, operation of the first magnetron power supply 154 and/or the second magnetron power supply 156 may be modified. For example, a power level of one or more of the magnetron power supplies 154, 156 may be adjusted based on the estimated volume to avoid flash boiling or otherwise reduce a risk of pressure buildup in the food container 120. Therefore, even partially full food containers 120 may be safely heated to a target temperature in the microwave appliance 100.

The I/O interface board 556 also includes an output block 556 for supplying output control signals 508 to components in the microwave compartment 133. A first magnetron signal 554 is provided to the first magnetron MOSFET to turn on or off the first power relay. Likewise, a second magnetron signal 556 is provided to the second magnetron MOSFET to turn on or off the second power relay. Upon the first power relay being turned on, power is provided to the first magnetron power supply 154 and a corresponding fan. Upon the second power relay being turned on, power is provided to the second magnetron power supply 156 and a corresponding fan.

A first power control signal 558 is provided to the first magnetron power supply 154 to modulate the power output by the first magnetron power supply 154 to the first magnetron. A second power control signal 560 is provided to the second magnetron power supply 156 to modulate the power output by the second magnetron power supply 156 to the second magnetron. In some implementations, the first and second power control signals 558, 560 are pulse width modulated control signals. The first and second power control signals 558, 560 may be the same or different. For example, the first and second magnetron power supplies 154, 156 may be operated to provide different power levels to their respective magnetrons.

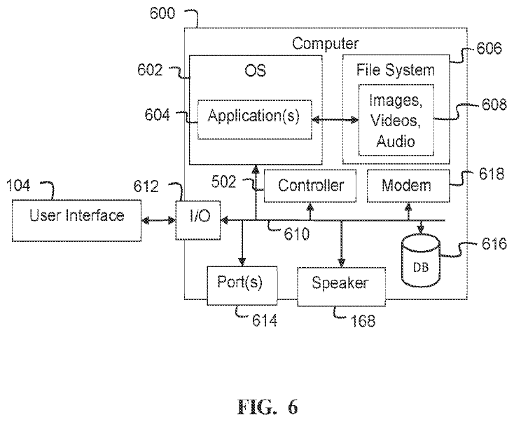

FIG. 6 is a block diagram of the computer system 600 of the microwave appliance 100. The computer system 600 includes an operating system 602 and one or more applications 604 installed on the operating system 602. The computer 600 also includes a memory 606 with a file system for storing images, audio, and video data 608 for display on the user interface 104 or output from the speaker 168. The one or more applications 604 control operation of components on a communications bus 610, such as the micro-controller 502. An I/O interface 612 provides communication between the one or more applications 604 and the user interface 104, for example supplying video or image data and receiving touch inputs from a touchscreen. A port 614, which may be accessible via the port access door 170, provides access to technicians to download usage and diagnostic data as well as to upload software updates for the application(s) 604 or the firmware 506. A database 616 may locally store the usage and diagnostic data for the microwave appliance 100. For example, the usage data may include how many times the door 102 is opened, which products are scanned by the product identification scanner 124, what temperature is selected on the user interface 104 to heat the products, and when each of these events occur. Other usage data may be collected. Diagnostic data may include logs of the inputs received on the input block 516, the analog input 544, and the analog amplifier 542 as well as the control signals 508. Other diagnostic data may be stored in the database 616. A modem 618 may also be included for uploading the usage and diagnostic data to a remote server (not shown) or for receiving software updates from the remote server. Other configurations and components are contemplated by this disclosure.

Operation of the microwave appliance 100 is based on the measured temperature of the food container 120 as determined by the temperature sensor 162. However, the temperature of the food container 120 is not an accurate measurement of a food product (e.g., beverage, soup, etc.) contained therein. The temperature of the food product may be higher than the temperature of the food container 120, particularly for higher temperature settings for the food product.

A control method is provided herein to calculate a target temperature of the food container 120 at which a heating cycle is to be stopped (e.g., turning off power to the magnetron(s)). The control method stops the heating cycle when the measured temperature of the food container 120 reaches the target temperature of the food container 120. The control method results in a final food product temperature within a tolerance (e.g., within +/−5%) of a temperature selection received from a consumer on the user interface 104 at the start of the heating cycle.

Test data of various categories and volumes of food products (e.g., beverages) to be heated in the microwave appliance 100 (e.g., water, tea, juice, coffee without cream/sugar, coffee with cream/sugar, etc.) is used to determine correlation values specific to a particular food container 120 placed within the microwave appliance 100. The control method uses a lookup table, which has correlation values for different combinations of food product attributes to use to calculate the target temperature of the food container 120. In some implementations, the calculation is a second-order polynomial equation which correlates the measured temperature of the food container 120 to a temperature of the food product contained therein, based on experimental data. A temperature of the microwave cavity 114 also affects the measured temperature of the food container 120. Accordingly, the temperature of the microwave cavity 114 may be used to determine an adjustment to the target temperature of the food container 120.

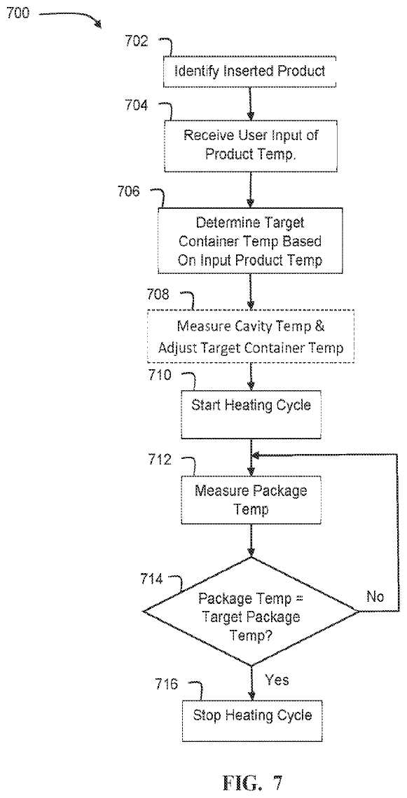

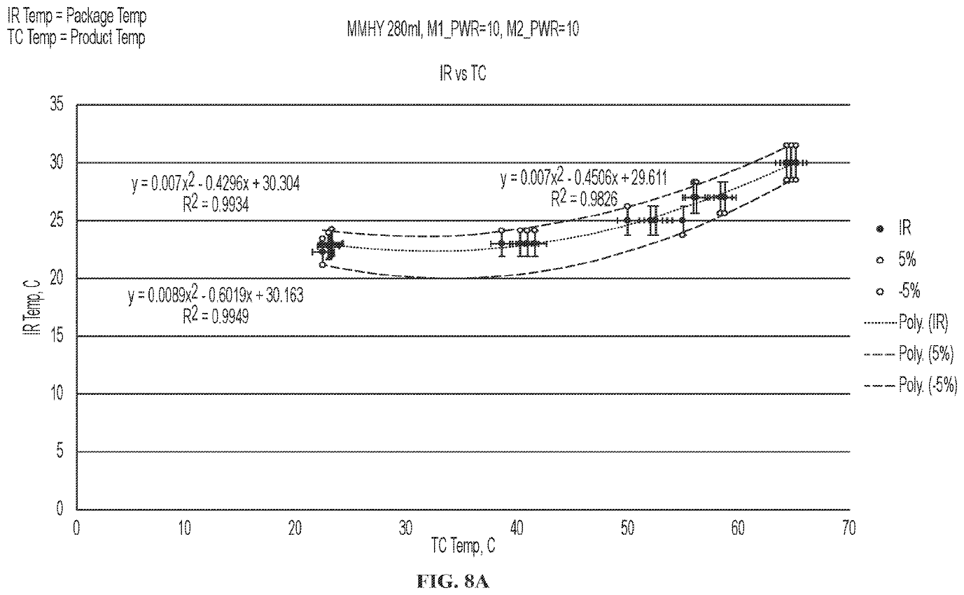

FIG. 7 is flow diagram of a control method 700 for a heating cycle performed by the microwave appliance 100. In various implementations, the control method 700 is executed by the micro-controller assembly 500 (e.g., micro-controller 502) and/or the computer system 600.

At 702, the control method 700 identifies the food container 120 inserted into the microwave appliance 100. For example, the product identification scanner 124 scans an identifier on the food container 120, as described above. Based on the identifier read from the food container 120 by the product identification scanner 124, the microwave appliance 100 is configured to identify a type or category of food product, a type of packaging, and/or a size or volume of packaging.

At 704, the control method 700 receives a user input via the user interface 104 of a product temperature for a food product within the food container 120 to be heated. The input product temperature may be an absolute temperature input received via input on the user interface 104 (e.g., 52° C.) or a relative temperature input (e.g., ambient, hot, very hot) received via input on the user interface 104. Relative temperature inputs may be configured within the microwave appliance 100 to correspond to particular absolute temperatures (e.g., a hot selection corresponds to 55° C., etc.).

At 706, the control method 700 determines a target temperature of the food container 120 that correlates with the input product temperature received via the user interface 104. The correlation between the temperature of the food container 120 and the temperature of the food product within the food container 120 is determined experimentally. While an example is provided herein of a second-order polynomial equation which models the relationship between the temperature of the food container 120 and the temperature of the food product within the food container 120, other statistical or machine learning methods may be used to model the values determined in the experimental results.

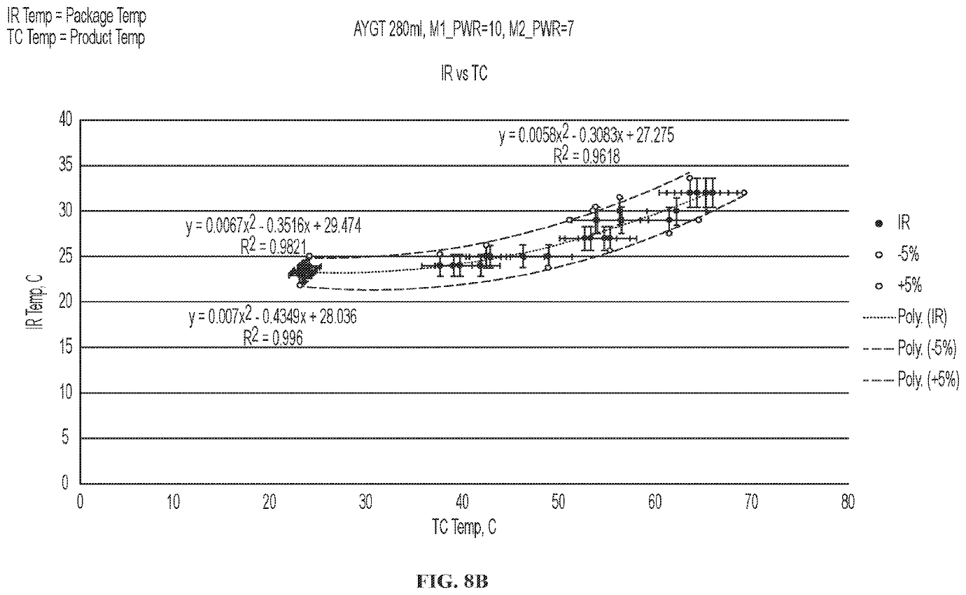

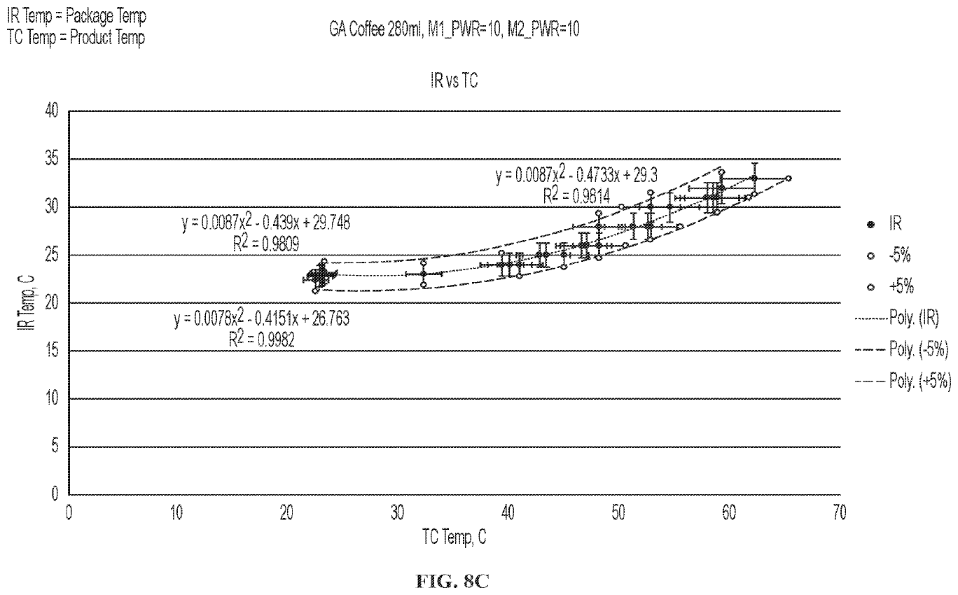

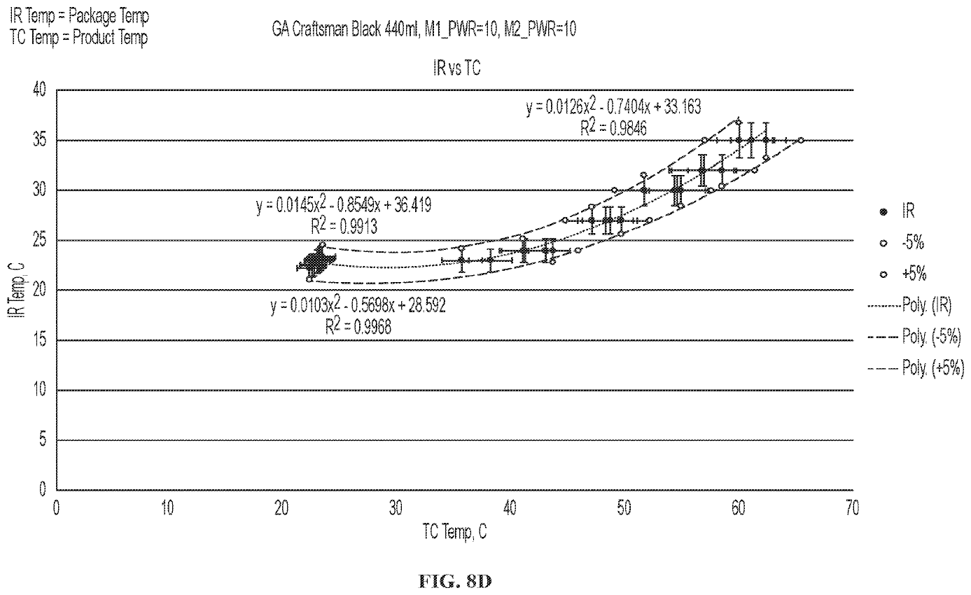

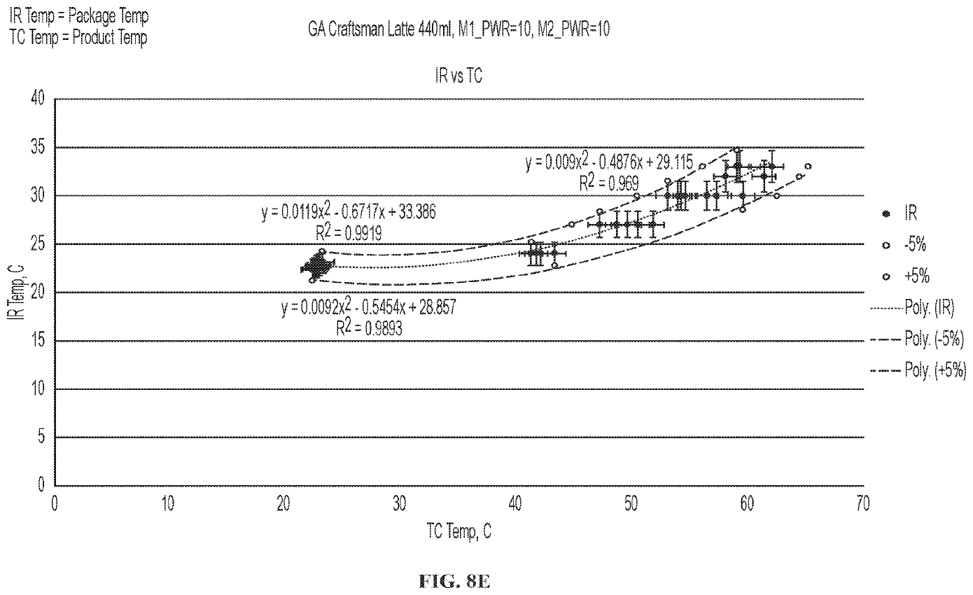

FIGS. 8A-8E are plots of experimental data and determined trend lines correlating a package temperature to a product temperature for various products. As shown, a non-linear relationship exist between the package temperature and the product temperature. Specifically, small changes in the package temperature (IR Temp) were found to result in large changes in the product temperature (TC Temp). Such non-linear effects were determined to be based in part on the increased pressure within the sealed food container 120 as it is heated. For example, the pressure within the food container 120 may increase to 8-22 psi in a heating cycle, more typically around 14 psi. The increasing pressure leads to non-linearity of the specific heat of water. Additionally, the insulating properties of the food container 120 dampen and delay the heat transfer from the food product to the food container 120.

Based on the experimental results, a second-order polynomial equation was determined to model the relationship between the temperature of the food container 120 and the temperature of the food product within a tolerance (e.g., within +/−5%) of a temperature selection received from a consumer on the user interface 104. The second-order polynomial equation is,

T_{c}=(X*Tₚ²)−(Y*Tₚ)+Z, Equation (1)

where T_{C} is the target temperature of the food container 120, T_{P} is the target temperature of the food product (e.g., the temperature selection received via the user interface 104), and each of X, Y, and Z are constants determined based on the experimental results.

In some examples, each of the constants X and Y are in turn determined from a second order polynomial that characterizes one or more physical attributes of the identified food container 120 (e.g., identified type or category of food product, type of packaging, size or volume of packaging, estimated volume of product based on electric field detector 538, etc.). In a specific example where the estimated volume of product detected within the food container 120 is a primary contributing factor,

X=6.67e⁻⁸x²−2.96e⁻⁵x+0.0109, Equation (2)

Y=5e⁻⁶x²−0.00265x+0.8117, Equation (3)

Z=29.6928, Equation (4)

where x is the estimated volume of produce detected by the electric field detector 538. In some implementations x is a value combining one or more of the physical attributes of the identified food container 120.

In some embodiments, the microwave appliance 100 may maintain a model for each product anticipated to be heated within the microwave appliance 100. However, such an approach requires extensive testing of each combination of product, packaging type, and package volume. Rather than individually testing each combination, the microwave appliance 100 may maintain one or more attribute multipliers that model the impact of each attribute variation on the determination of the target temperature of the product container 120. In some implementations, a single attribute multiplier may be used. In some implementations, more than one attribute multiplier may be used. Each of the one or more attribute multipliers is multiplied by the value of Equation (1) as,

$${T}_{o} = ( ( X * {T}_{p}^{2} ) - ( Y * {T}_{p} ) + Z ) {\prod }_{1}^{n} {α}_{m} , \qquad Equation ( 5 )$$

where aₘ is the attribute multiplier(s) and n is the number of attribute multipliers. Therefore, the attribute multiplier(s) scale the target temperature of the product container 120 based on the attribute(s) of the product container determined based on the identifier read from the food container 120 by the product identification scanner 124.

For example, for beverage food products, a category multiplier may include a coffee multiplier of 1.2, a tea multiplier of 1.1, a juice multiplier of 1.07, a water multiplier of 1.25, an animal milk multiplier of 1.4, and a plant dairy multiplier of 1.3. Likewise, a package volume multiplier may include a 1.15 multiplier for beverage containers between 100-225 mL, a 1.25 multiplier for beverage containers between 226-350 mL, a 1.35 multiplier for beverage containers between 351-475 mL, and a 1.4 multiplier for beverage containers between 476-600 mL. Other attribute multipliers and values for those multipliers are contemplated by this disclosure.

Returning to FIG. 7, at 708, the control method 700 optionally measures a temperature of the microwave cavity 114. A temperature of the microwave cavity 114 also affects the measured temperature of the food container 120. Accordingly, the temperature of the microwave cavity 114 may be used to determine an adjustment to the target temperature of the food container 120. As the temperature within the microwave cavity 114 increases, the temperature of the food container 120 likewise increases based on the heat present within the microwave cavity 114. Accordingly, the target temperature of the food container 120 is reached sooner than with a lower temperature in the microwave cavity 114. Therefore, a cavity temperature adjustment may be added to Equation (1) or Equation (5), respectively, as,

$${T}_{o} = ( ( X * {T}_{p}^{2} ) - ( Y * {T}_{p} ) + Z ) + {C}_{T} , \qquad Equation ( 6 )$$

$${T}_{o} = ( ( X * {T}_{p}^{2} ) - ( Y * {T}_{p} ) + Z ) {\prod }_{1}^{n} {a}_{m} + {C}_{T} , \qquad Equation ( 7 )$$

where C_{T} is the cavity temperature adjustment. In an example, the cavity temperature adjustment, C_{T}, is 0° C. when the temperature of the microwave cavity 114 is 22° C., 4° C. when the temperature of the microwave cavity 114 is 85° C., and a linear extrapolation therebetween for other temperatures of the microwave cavity 114.

At 710, the control method 700 starts the heating cycle by turning on power to the magnetron(s). At 714, the control method 700 receives a measurement of a temperature of the food container 120 using the temperature sensor 162. At 716, the control method 700 determines whether the measured temperature of the food container 120 is equal to the target temperature of the food container 120. If not, the control method 700 continues the heating cycle and proceeds back to 712. Otherwise, if the measured temperature of the food container 120 is equal to the determined target temperature of the food container, the control method stops the heating cycle (e.g., turns off power to the magnetron(s)), at 716. Accordingly, the product within the food container 120 is heated to the input product temperature received at the user interface 104 to within a tolerance (e.g., within +/−5%).

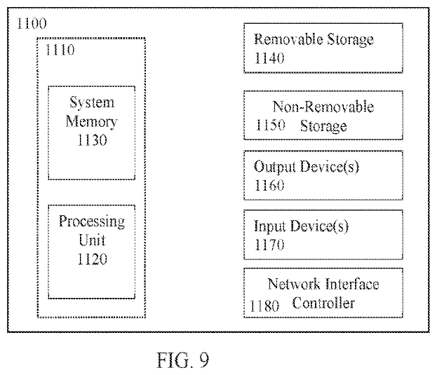

It should be appreciated that the logical operations described herein with respect to the various figures may be implemented (1) as a sequence of computer implemented acts or program modules (i.e., software) running on a computing device (e.g., the computing device described in FIG. 9), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 9, an example computing device 1100 upon which embodiments of the invention may be implemented is illustrated. For example, the microwave appliance 100, user interface 104, micro-controller 502, and/or computer 600 described herein may each be implemented as a computing device, such as computing device 1100. It should be understood that the example computing device 1100 is only one example of a suitable computing environment upon which embodiments of the invention may be implemented. Optionally, the computing device 1100 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In an embodiment, the computing device 1100 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computing device 1100 to provide the functionality of a number of servers that is not directly bound to the number of computers in the computing device 1100. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In its most basic configuration, computing device 1100 typically includes at least one processing unit 1120 and system memory 1130. Depending on the exact configuration and type of computing device, system memory 1130 may be volatile (such as random access memory (RAM)), non-volatile (such as read-only memory (ROM), flash memory, etc.), or some combination of the two. This most basic configuration is illustrated in FIG. 9 by dashed line 1110. The processing unit 1120 may be a standard programmable processor that performs arithmetic and logic operations necessary for operation of the computing device 1100. While only one processing unit 1120 is shown, multiple processors may be present. Thus, while instructions may be discussed as executed by a processor, the instructions may be executed simultaneously, serially, or otherwise executed by one or multiple processors. The computing device 1100 may also include a bus or other communication mechanism for communicating information among various components of the computing device 1100.

Computing device 1100 may have additional features/functionality. For example, computing device 1100 may include additional storage such as removable storage 1140 and non-removable storage 1150 including, but not limited to, magnetic or optical disks or tapes. Computing device 1100 may also contain network connection(s) 1180 that allow the device to communicate with other devices such as over the communication pathways described herein. The network connection(s) 1180 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. Computing device 1100 may also have input device(s) 1170 such as a keyboards, keypads, switches, dials, mice, track balls, touch screens, voice recognizers, card readers, paper tape readers, or other well-known input devices. Output device(s) 1160 such as a printers, video monitors, liquid crystal displays (LCDs), touch screen displays, displays, speakers, etc. may also be included. The additional devices may be connected to the bus in order to facilitate communication of data among the components of the computing device 1100. All these devices are well known in the art and need not be discussed at length here.

The processing unit 1120 may be configured to execute program code encoded in tangible, computer-readable media. Tangible, computer-readable media refers to any media that is capable of providing data that causes the computing device 1100 (i.e., a machine) to operate in a particular fashion. Various computer-readable media may be utilized to provide instructions to the processing unit 1120 for execution. Example tangible, computer-readable media may include, but is not limited to, volatile media, non-volatile media, removable media and non-removable media implemented in any method or technology for storage of information such as computer readable instructions, data structures, program modules or other data. System memory 1130, removable storage 1140, and non-removable storage 1150 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

In an example implementation, the processing unit 1120 may execute program code stored in the system memory 1130. For example, the bus may carry data to the system memory 1130, from which the processing unit 1120 receives and executes instructions. The data received by the system memory 1130 may optionally be stored on the removable storage 1140 or the non-removable storage 1150 before or after execution by the processing unit 1120.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Embodiments of the methods and systems may be described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A microwave appliance, comprising:
one or more microwave sources;
a microwave chamber in electromagnetic communication with the one or more microwave sources;
a product holder configured to support a food container within the microwave chamber;
a temperature sensor configured to sense a temperature of the food container supported within the product holder;
a user interface configured to receive a temperature selection; and
a controller in communication with the temperature sensor and the user interface configured to determine a target temperature of the food container based on the temperature selection and operate the one or more microwave sources to heat a food product in the food container until the temperature of the food container is equal to the target temperature of the food container.

2. The microwave appliance of claim 1, wherein the controller is configured to determine the target temperature of the food container based on a model of experimental results that relates the temperature of the food container to a temperature of the food product in the food container.

3. The microwave appliance of claim 2, wherein the food product is sealed within the food container.

4. The microwave appliance of claim 2, wherein the model is a second-order polynomial equation,
T_{c}=(X*Tₚ²)−(Y*Tₚ)+Z,
where T_{C} is the target temperature of the food container, T_{P} is the temperature selection, and each of X, Y, and Z are constants determined based on the experimental results.

5. The microwave appliance of claim 2, further comprising:
a product identification scanner in communication with the controller and configured read an identifier on the food container, wherein the controller is configured to determine a product attribute of the food container based on the identifier.

6. The microwave appliance of claim 5, wherein the model includes an attribute multiplier that scales the target temperature of the food container based on the product attribute.

7. The microwave appliance of claim 6, wherein the product attribute is selected from the group of product attributes consisting of: a type of food product, a type of packaging, a size of packaging, and combinations thereof.

8. The microwave appliance of claim 2, further comprising:
a second temperature sensor configured to sense a temperature of the microwave chamber, wherein the model includes a cavity temperature adjustment that is added to the target temperature of the food container based on the temperature of the microwave chamber.

9. The microwave appliance of claim 8, wherein the cavity temperature adjustment is 0° C. when the temperature of the microwave chamber is 22° C., 4° C. when the temperature of the microwave chamber is 85° C., and a linear extrapolation therebetween for other temperatures of the microwave chamber.

10. The microwave appliance of claim 1, wherein the controller is configured to operate the one or more microwave sources to heat the food product in the food container temperature to within a tolerance of the temperature selection, wherein the tolerance is +/−5%.

11. A method of operating a microwave appliance, comprising:
receiving a temperature selection from a user interface;
determining a target temperature of a food container based on the temperature selection;
powering one or more microwave sources to heat a food product in a food container within a microwave chamber;
sensing a temperature of the food container with a temperature sensor; and
turning off power to one or more microwave sources upon the temperature of the food container reaching the target temperature.

12. The method of claim 11, wherein determining the target temperature of the food container is based on a model of experimental results that relates the temperature of the food container to a temperature of the food product in the food container.

13. The method of claim 12, wherein the food product is sealed within the food container.

14. The method of claim 12, wherein the model is a second-order polynomial equation,
T_{c}=(X*Tₚ²)−(Y*Tₚ)+Z,
where T_{C} is the target temperature of the food container, T_{P} is the temperature selection, and each of X, Y, and Z are constants determined based on the experimental results.

15. The method of claim 12, further comprising:
identifying the food container based on scanning an identifier on the food container by a product identification scanner; and
determining a product attribute of the food container based on the identifier.

16. The method of claim 15, wherein the model includes an attribute multiplier that scales the target temperature of the food container based on the product attribute.

17. The method of claim 16, wherein the product attribute is selected from the group of product attributes consisting of: a type of food product, a type of packaging, a size of packaging, and combinations thereof.

18. The method of claim 12, further comprising:
sensing a temperature of the microwave chamber with a second temperature sensor; wherein the model includes a cavity temperature adjustment that is added to the target temperature of the food container based on the temperature of the microwave chamber.

19. The method of claim 18, wherein the cavity temperature adjustment is 0° C. when the temperature of the microwave chamber is 22° C., 4° C. when the temperature of the microwave chamber is 85° C., and a linear extrapolation therebetween for other temperatures of the microwave chamber.

20. The method of claim 1, wherein the food product in the food container is heated to a temperature within a tolerance of the temperature selection, wherein the tolerance is +/−5%.
